(19) United States
(12) Patent Application Publication
(10) Pub. No.: US 2017/0288259 A1
(43) Pub. Date: Oct. 5, 2017

(54) ELECTRICITY STORAGE DEVICE

(71) Applicant: KABUSHIKI KAISHA TOYOTA JIDOSHOKKI, Kariya-shi, Aichi-ken (JP)

(72) Inventors: Atsushi MINAGATA, Kariya-shi (JP); Motoaki OKUDA, Kariya-shi (JP)

(73) Assignee: Kabushiki Kaisha Toyota Jidoshokki, Kariya-shi, Aichi-ken (JP)

(21) Appl. No.: 15/512,206

(22) PCT Filed: Sep. 17, 2015
(86) PCT No.: PCT/JP2015/076558

§ 371 Date: Mar. 17, 2017

(30) Foreign Application Priority Data
Sep. 22, 2014 (JP) 2014-192592

(51) Int. Cl. H01M 10/0525; H01M 2/02; H01M 10/44; H01M 4/04; H01M 10/04

(52) U.S. Cl. CPC H01M 10/0525; H01M 4/0404; H01M 10/0468; H01M 10/44; H01M 2/0212; H01M 2004/027

(57) ABSTRACT

This electricity storage device is provided with an electrode assembly. The electrode assembly is constructed by laminating two electrodes of different polarities and a separator disposed between the electrodes with the electrodes being insulated from each other. Each of the electrodes has a metal foil and active material layers that are formed by coating an active material on the metal foil in a coating direction. The elongation rate of the separator varies in different directions, and the separator has a direction in which the elongation rate is higher than in the other directions. The higher elongation rate direction of the separator intersects the coating direction of the active material on at least one of the electrodes.

### TECHNICAL FIELD

The present invention relates to an electricity storage device.

### BACKGROUND ART

Rechargeable batteries such as lithium-ion batteries are mounted on vehicles such as electric vehicles (EV) and plug-in hybrid vehicles (PHV). The rechargeable batteries are used as electricity storage devices that store electric power supplied to a motor, which serves as a drive source. For example, Patent Document 1 discloses a rechargeable battery having an electrode assembly. The electrode assembly is configured by stacking positive electrodes and negative electrodes with separators held in between. Each positive-electrode active material layer includes a positive-electrode foil and a positive-electrode active material layer provided by coating the positive-electrode foil with positive-electrode material. Each negative electrode includes a negative-electrode foil and a negative-electrode active material layer provided by coating the negative-electrode foil with negative-electrode material.

### PRIOR ART DOCUMENT

### Patent Document

Patent Document 1: Japanese National Phase Laid-Open Publication No.09-120836

### SUMMARY OF THE INVENTION

### Problem that the Invention is to Solve

In such a rechargeable battery, in forming an active material layer by coating the foil of an electrode with active material, projections may form on the surface of the active material layer due to coating unevenness of the active material and clumping, which is aggregation of the active material. When inspection is performed after coating with the active material, electrodes having projections that have thickness out of the standard can be eliminated from electrodes having projections. However, when electrodes with projections within the standard are not eliminated or the inspection accuracy is low, it is difficult to eliminate electrodes having projections. Thus, the electrodes having projections may remain.

In a rechargeable battery in which electrodes having projections on the surface of the active material layers are stacked, when the electrodes and the separators are stacked or the rechargeable battery expands during use, the projections apply load to the corresponding separator. In such a case, the projections damage the separator, and the corresponding positive and negative electrodes may be short-circuited.

It is an objective of the present invention to provide an electricity storage device that limits the occurrence of damage on a separator even if the surface of the corresponding active material layer has projections.

### Means for Solving the Problems

One aspect to achieve the above objective provides an electricity storage device including an electrode assembly. The electrode assembly is configured by stacking two electrodes that have different polarities from each other and a separator that is arranged between the electrodes in a state in which the electrodes are insulated from each other. Each of the electrodes has a foil and an active material layer in which active material is coated on the foil in a coating direction. The separator has stretchabilities according to directions. The separator has one direction in which the stretchability is higher than in the other directions. The direction of the high stretchability in the separator intersects the coating direction of the active material of at least one of the electrodes.

### BRIEF DESCRIPTION OF THE DRAWINGS

FIG. 1 is an exploded perspective view of a rechargeable battery according to one embodiment.

FIG. 2 is a perspective view illustrating the appearance of the rechargeable battery of FIG. 1.

FIG. 3 is an exploded perspective view illustrating components of the electrode assembly.

FIG. 4 is a partial cross-sectional view of the electrode assembly of FIG. 3.

### MODES FOR CARRYING OUT THE INVENTION

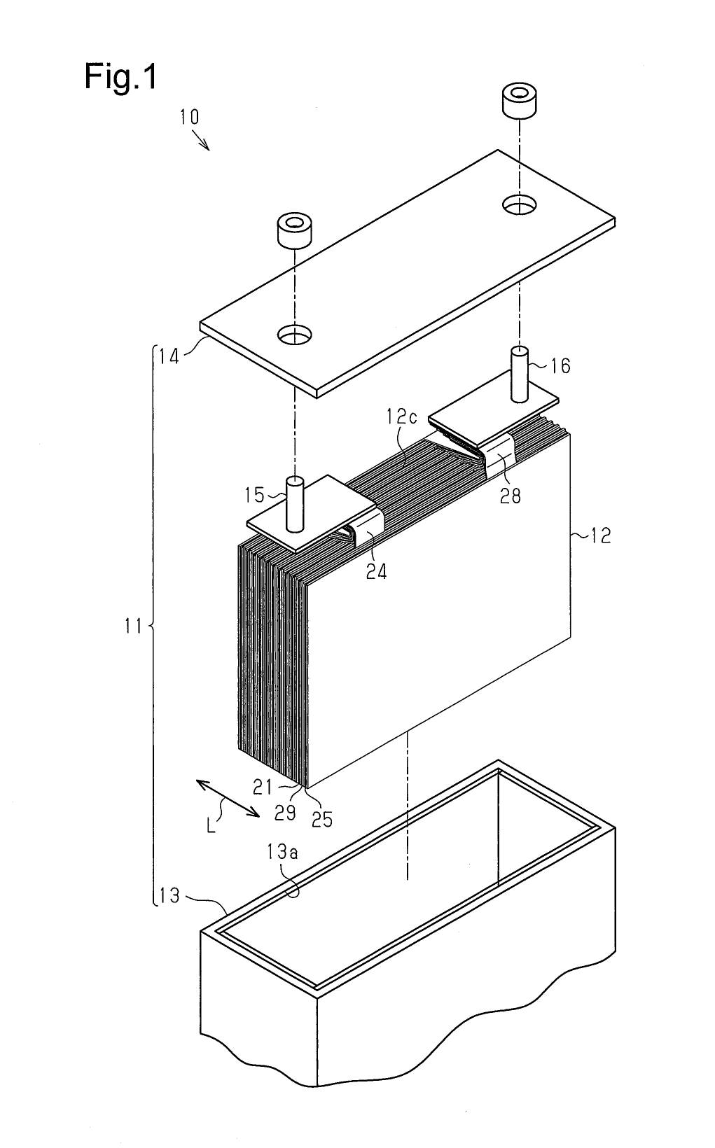

With reference to FIGS. 1 to 4, an electricity storage device according to one embodiment will now be described.

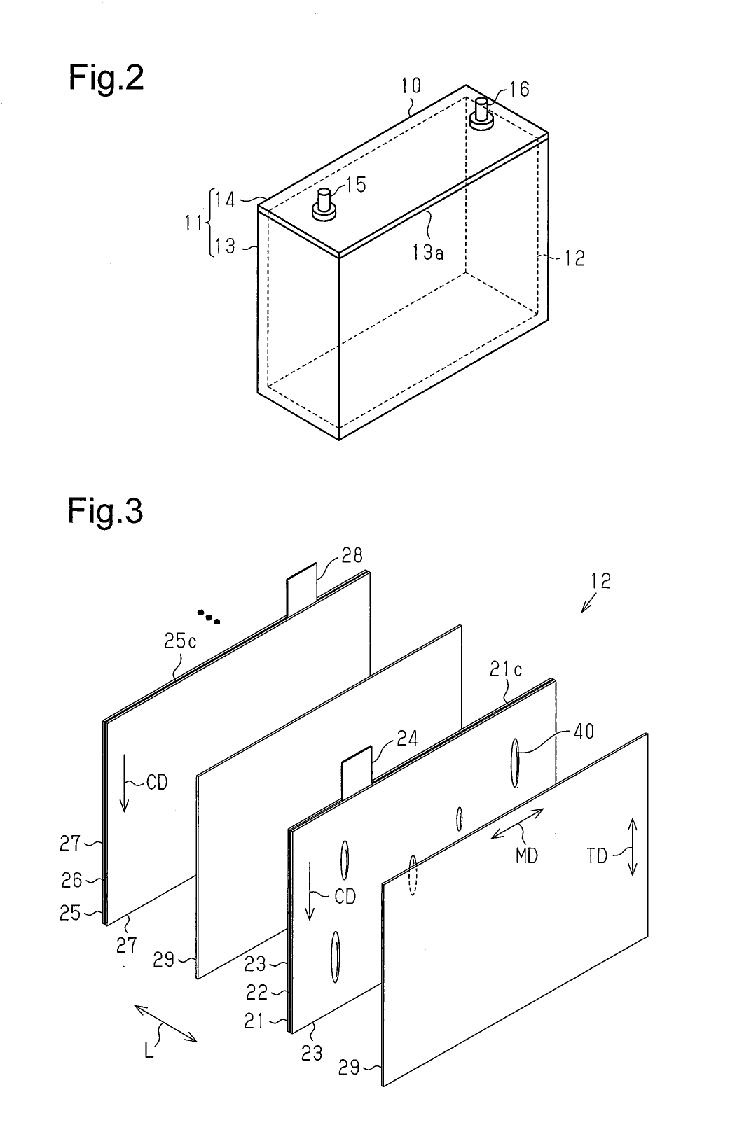

As shown in FIGS. 1 and 2, a rechargeable battery 10, which is an electricity storage device, includes an electrode assembly 12 in a case 11. The case 11 also contains electrolyte with the electrode assembly 12. The case 11 includes a tubular case body 13 with a closed bottom, and a plate-shaped lid 14. The case body 13 has an opening 13a through which the electrode assembly 12 is inserted. The lid 14 closes the opening 13a. The case body 13 and the lid 14 are both made of metal (for example, stainless steel and aluminum). Further, in this embodiment, the case body 13 is shaped as a rectangular tube with a closed bottom. The lid 14 has a rectangular plate-like shape. Thus, the rechargeable battery 10 is a prismatic battery having a rectangular outer shape. Further, the rechargeable battery 10 of this embodiment is a lithium-ion battery.

As shown in FIG. 3, the electrode assembly 12 is configured by stacking electrodes 21 and 22, which have different polarities from each other, and separators 29, each of which is arranged between electrodes 21 and 22 to insulate the electrodes 21 and 22 from each other. Specifically, the electrode assembly 12 is configured such that positive electrodes 21 and negative electrodes 25 are alternately stacked with separators 29 held in between. In the present embodiment, the positive electrodes 21, the negative electrodes 25, and the separators 29 are all rectangular.

Each positive electrode 21 includes a rectangular positive-electrode foil (e.g., an aluminum foil) 22 and positive-electrode active material layers 23 constituted by positive-electrode material arranged on the opposite surfaces of the positive-electrode foil 22. The positive-electrode active material layers 23 are obtained by drying, pressing, and baking the positive-electrode foil 22 on which positive-electrode material mixture including positive-electrode material, conductive agent, binder, and solvent is coated. In the positive electrode 21 according to the present embodiment, the direction indicated by the arrow CD in FIG. 3 is the coating direction of the positive-electrode material mixture in the positive-electrode active material layers 23 (hereinafter, referred to as the CD direction of the positive electrode 21). The positive-electrode active material layers 23 are configured such that the CD direction of the positive electrode 21 coincides with the transverse direction of the positive electrode 21. Further, the positive electrode 21 has a positive-electrode tab 24. The positive-electrode tab 24 is formed of the positive-electrode foil 22, which has a shape that protrudes from a part of one side 21c extending in the longitudinal direction of the positive electrode 21.

Each negative electrode 25 is configured by a rectangular negative-electrode foil (e.g., a copper foil) 26 and negative-electrode active material layers 27 constituted by negative-electrode active material arranged on the opposite surfaces of the negative-electrode foil 26. The negative-electrode active material layers 27 are obtained by drying, pressing, baking the negative-electrode foil 26 on which negative-electrode active material mixture including negative-electrode active material, conductive agent, binder, and solvent is coated. In the negative electrode 25 according to the present embodiment, the direction indicated by the arrow CD in FIG. 3 is the coating direction of the negative-electrode active material mixture in the negative-electrode active material layers 27 (hereinafter, referred to as the CD direction of the negative electrode 25). The negative-electrode active material layers 27 are configured such that the CD direction of the negative electrode 25 coincides with the transverse direction of the negative electrode 25.

Further, in the present embodiment, in comparison with the negative-electrode active material layers 27 of the negative electrode 25, the positive-electrode active material layers 23 of the positive electrode 21 are pressed with high pressure, thereby having a high density. Thus, the positive-electrode active material layers 23 are harder than the negative-electrode active material layers 27. Further, the negative electrode 25 has a negative-electrode tab 28. The negative-electrode tab 28 is formed of the negative-electrode foil 26 having a shape that protrudes from a part of one side 25c extending in the longitudinal direction of the negative electrode 25.

The separator 29 is made of plastic (e.g., polyethylene), which has an insulating property. The separator 29 is manufactured by cutting an elongated rectangular sheet of separator sheet material into a desired size. In the present embodiment, the separator sheet material is manufactured by uniaxial stretching in which the separator material is stretched in one direction. Thus, in the separator 29, fibers are oriented in a machine direction at manufacturing, that is, the MD direction. In the separator 29, the direction orthogonal to the MD direction is defined as a TD direction. The separator 29 has stretchabilities according to directions. The separator 29 has a direction (the MD direction) in which the stretchability is higher than in the TD direction. The stretchability in the MD direction of the separator 29 is higher than the stretchabilities in the other directions. That is, the separator 29 has the highest stretchability in the MD direction. The separator 29 according to the present embodiment is configured such that the MD direction coincides with the longitudinal direction of the separator 29 and the TD direction coincides with the transverse direction of the separator 29.

In the electrode assembly 12, the positive electrodes 21, the negative electrodes 25, and the separators 29 are stacked while their longitudinal directions coincide with one another. Thus, in the electrode assembly 12, the electrodes 21 and 25 and the separators 29 are arranged such that the CD direction of the positive electrodes 21 and the CD direction of the negative electrodes 25 are orthogonal to the MD direction of the separators 29 as viewed from the stacking direction L of the electrode assembly 12. The electrodes 21 and 25 of the electrode assembly 12 are stacked such that the tabs 24, 28 of the same polarity are arranged in series in the stacking direction L. Thus, the tabs 24, 28 of different polarities do not overlap in the stacking direction L.

As shown in FIG. 1, in the rechargeable battery 10, the electrode assembly 12 has four edges that are located orthogonal to the stacking direction L. The positive electrodes 21 and the negative electrodes 25 are stacked such that the positive-electrode tabs 24 and the negative-electrode tabs 28 protrude from the upper edge 12c, which is one of the four edges. The positive-electrode tabs 24 are folded in a state in which the positive-electrode tabs 24 are gathered within a range from one end to the other end in the stacking direction L of the electrode assembly 12. The positive-electrode tabs 24 are electrically connected to each other by welding portions of the positive-electrode tabs 24 that overlap. In a similar manner, the negative-electrode tabs 28 are folded in a state in which the negative-electrode tabs 28 are gathered. The negative-electrode tabs 28 are electrically connected to each other by welding portions of the negative-electrode tabs 28 that overlap.

The rechargeable battery 10 includes a positive terminal 15 that is electrically connected to the positive-electrode tabs 24, and a negative terminal 16 that is electrically connected to the negative-electrode tabs 28. A part of each terminal 15, 16 is exposed to the exterior of the case 11 through a through-hole in the lid 14.

Operation of the rechargeable battery 10 according to the present embodiment will now be described.

In the rechargeable battery 10, the active material layers 23, 27 are obtained by coating the foils 22, 26 of the electrodes 21, 25 with active material mixture. At this time, as shown in FIG. 3, projections 40 may form on the surfaces of the active material layers 23, 27 due to coating unevenness of the active material mixture and clumping, which is aggregation of the active material.

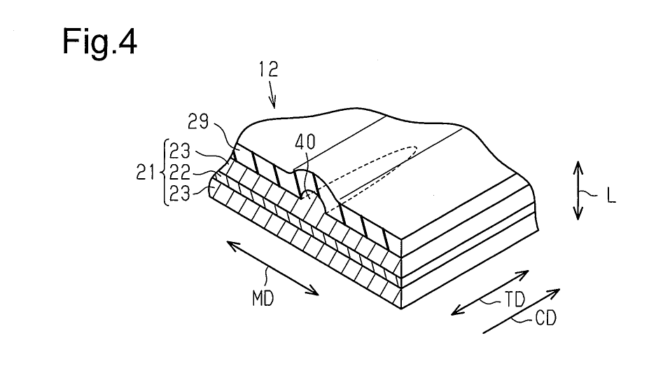

FIGS. 3 and 4 show an example case in which the projections 40 have formed on the surface of one of the positive-electrode active material layers 23 of the positive electrode 21. In the following, operation will be described when the projections 40 have formed on the surface of the positive-electrode active material layer 23 of the positive electrode 21. Thus, the following description can be read as operation when the projections 40 have formed on the surface of one of the negative-electrode active material layers 27 of the negative electrode 25 if the positive electrode 21 is replaced by the negative electrode 25, the positive-electrode active material layer 23 is replaced by the negative-electrode active material layer 27, and the CD direction of the positive electrode 21 is replaced by the CD direction of the negative electrode 25 in the following.

As shown in FIG. 4, the positive electrode 21 with the positive-electrode active material layer 23 having the projections 40 on the surface is stacked. In the electrode assembly 12 restrained in the stacking direction L, the projections 40 dig into the corresponding separator 29. The separator 29 is pulled in the longitudinal direction of the projections 40 and in all directions that intersect the longitudinal direction. The separator 29 is pulled with the strongest force in the direction orthogonal to the longitudinal direction (in the transverse direction of the projections 40) among the directions that intersect the longitudinal direction of the projections 40. At this time, the MD direction of the separator 29, in which stretchability is high, coincides with the transverse direction of the projections 40. Thus, even if the separator 29 is pulled in the transverse direction of the projections 40 due to the projections 40, the separator 29 stretches and is flexible to be pulled.

Therefore, the present embodiment achieves the following advantages.
(1) The MD direction of the separator 29, in which stretchability is high, intersects the CD direction of the positive electrode 21 and the CD direction of the negative electrode 25. Thus, even when the projections 40 form in the CD direction of each electrode, the MD direction of the separator 29 stretches in the direction that intersects the longitudinal direction of the projections 40. As a result, the projections 40 dig into the separator 29, and the separator 29 is strongly pulled in directions that intersect the longitudinal direction of the projections 40. Even in this case, the separator 29 flexibly stretches. This limits the occurrence of damage such as cracks on the separator 29.
(2) The CD direction of the positive electrode 21 and the CD direction of the negative electrode 25 are orthogonal to the MD direction of the separator 29. The closer the angle that intersects the longitudinal direction of the projections 40 is to a right angle, the stronger the projections 40 pull the separator 29. At this time, when the MD direction of the separator 29 stretches in the transverse direction that is orthogonal to the longitudinal direction of the projections 40, the separator 29 flexibly stretches even if the separator 29 is strongly pulled. This properly limits the occurrence of damage such as cracks on the separator 29.
(3) Of the positive-electrode active material layer 23 and the negative-electrode active material layer 27, the projections 40 on the active material layer that is softer than the other are easily dented when load is applied due to the restraint in the stacking direction and the like. In contrast, the projections 40 on the active material layer that is harder than the other are not easily dented. Thus, when the projections 40 dig into the separator 29, the force of pulling the separator 29 is also stronger. In this way, the CD direction of the positive electrode 21 having the positive-electrode active material layer 23 that is harder than the other intersects the MD direction of the separator 29. Thus, even if the projections 40 greatly pull the separator 29, the separator 29 flexibly stretches so that the damage on the separator 29 is limited.
(4) Since damage on the separator 29 due to the projections 40 are limited, the inspection standard can be relaxed in the inspection performed after coating of the active material mixture on the electrodes 21 and 25. Therefore, the number of processes for inspection performed after coating of the active material mixture on the electrodes 21, 25 can be reduced.

The above-illustrated embodiment may be modified in the following forms.

The CD direction of the positive electrode 21 or the CD direction of the negative electrode 25 may intersect the MD direction of the separator 29. When the positive-electrode active material layer 23 is harder than the negative-electrode active material layer 27, it is preferable that the CD direction of the positive electrode 21 intersect the MD direction of the separator 29. When the negative-electrode active material layer 27 is harder than the positive-electrode active material layer 23, it is preferable that the CD direction of the negative electrode 25 intersect the MD direction of the separator 29.

Even when there is no difference in the hardness between the positive-electrode active material layer 23 and the negative-electrode active material layer 27, the embodiment may be modified as long as the MD direction of the separator 29 intersects the CD direction of the positive electrode 21 and the CD direction of the negative electrode 25.

The MD direction of the separator 29 does not necessarily need to be orthogonal to the CD direction of the positive electrode 21 and the CD direction of the negative electrode 25. For example, the angle at which a straight line extending in the MD direction of the separator 29 intersects a straight line extending in the CD direction of the electrodes 21, 25 may be 60°, 45°, or 30°. Further, the angle may be less than 5°. The embodiment may be modified as long as the MD direction of the separator 29 is non-parallel with the CD direction of the positive electrode 21 and the CD direction of the negative electrode 25.

The CD direction of the positive electrode 21 or the negative electrode 25 may coincide with a direction other than the transverse direction of the electrodes 21, 25. For example, the CD directions of the positive electrode 21 and the negative electrode 25 may coincide with the longitudinal directions of the electrodes 21, 25. In this case, the MD direction of the separator 29 coincides with a direction other than the longitudinal direction of the separator 29. For example, the MD direction of the separator 29 coincides with the transverse direction of the separator 29.

The electrodes 21 and 25 and the separator 29 may have a shape other than rectangular. For example, it may be a square.

The separator 29 may be an electrode accommodation separator, which accommodates one of the positive electrode 21 and the negative electrode 25 therein. In this case, the MD direction of the electrode accommodation separator intersects the CD directions of the accommodated electrodes.

The separator 29 may be of separator sheet material manufactured by biaxial stretching, in which separator material is stretched in two directions orthogonal to each other. Even in this form, the separator 29 is arranged such that the direction of one of the two axes that has higher stretchability than the stretchability of the other axis intersects the CD direction of at least one of the positive electrode 21 and the negative electrode 25. According to this, when the stretchability in the direction along one axis is higher than the stretchability of the direction along another axis, the direction of the highest stretchability intersects the CD direction. Even in a case in which the direction of the highest stretchability is not any one of the two axes, if the separator is arranged such that the direction of one of the two axes that has the higher stretchability intersects the CD direction at a right angle, the separator is allowed to be arranged such that the direction in which the stretchability is the highest intersects the CD direction.

Only one of the two surfaces of the positive electrode 21 may have the positive-electrode active material layer 23.

Only one of the two surfaces of the negative electrode 25 may have the negative-electrode active material layer 27.

The rechargeable battery 10 is not limited to a lithium-ion rechargeable battery. The rechargeable battery 10 may be a rechargeable battery of other types. That is, any rechargeable batteries may be applicable in which ions move between the positive-electrode active material layer and the negative-electrode active material layer to exchange charges.

The shape of the case 11 may be modified. For example, the case 11 may have a cylindrical shape.

As an electrode assembly, a rolling body obtained by rolling up a belt-shaped single positive electrode and a belt-shaped single negative electrode may be adopted. In this form, for example, the electrodes are rolled up such that at least one of the CD direction of the positive electrode and the CD direction of the negative electrode coincides with the rolling directions of the electrode and the separator. The separator is arranged between the electrodes such that the direction in which stretchability is higher intersects the rolling direction of the electrodes. Even the rechargeable battery having an electrode assembly of such a rolling body achieves the advantages similar to the advantages of the above embodiment.

The present invention may be implemented to an electricity storage device such as an electric double layer capacitor.

1. An electricity storage device comprising an electrode assembly, wherein
electrodes that have different polarities from each other with a separator that insulates the electrodes from each other,
each of the electrodes has a rectangular foil, an active material layer in which active material is arranged on the foil, and a tab protruding from a part of one side extending in a longitudinal direction of the foil,
one end in the longitudinal direction of the electrode coincides with one end in the longitudinal direction of the active material layer,
the other end in the longitudinal direction of the electrode coincides with the other end in the longitudinal direction of the active material layer,
the active material has a constant coating direction,
the separator has one direction in which the stretchability of the separator is higher than in the other directions,
the coating direction of the active material in at least one of the electrodes is a direction along the protruding direction of the tab, and
the direction of the high stretchability in the separator is orthogonal to the coating direction of the active material of at least one of the electrodes.

2. The electricity storage device according to claim 1, wherein
one of the active material layers of the electrodes, which have different polarities, is harder than the other active material layer, and
the direction of the high stretchability in the separator is orthogonal to the coating direction of the active material in the electrode having the harder active material layer.

3. The electricity storage device according to claim 1, wherein the direction of the high stretchability in the separator is orthogonal to the coating direction of the active material.

4. The electricity storage device according to claim 1, wherein the electricity storage device is a rechargeable battery.

5. The electricity storage device according to claim 1, wherein
the separator is configured by biaxial stretching, in which separator material is stretched in two directions orthogonal to each other, and
one of the two axes has higher stretchability than the stretchability of the other axis.

6. An electricity storage device comprising an electrode assembly, wherein
the electrode assembly is configured by stacking electrodes that have different polarities from each other with a separator that insulates the electrodes from each other,
each of the electrodes has a rectangular foil, an active material layer in which active material is arranged on the foil, and a tab protruding from a part of one side extending in a longitudinal direction of the foil,
one end in the longitudinal direction of the electrode coincides with one end in the longitudinal direction of the active material layer,
the other end in the longitudinal direction of the electrode coincides with the other end in the longitudinal direction of the active material layer,
the active material has a constant coating direction,
the separator has one direction in which the stretchability of the separator is higher than in the other directions,
the coating direction of the active material in at least one of the electrodes is a direction along the protruding direction of the tab,
the direction of the high stretchability in the separator intersects the coating direction of the active material of at least one of the electrodes,
the separator is one of a plurality of separators that constitutes the electrode assembly, and
the separators are stacked such that the directions of the high stretchabilities coincide with each other.

7. The electricity storage device according to claim 6, wherein
one of the active material layers of the electrodes, which have different polarities, is harder than the other active material layer, and
the direction of the high stretchability in the separator intersects the coating direction of the active material in the electrode having the harder active material layer.

8. The electricity storage device according to claim 6, wherein the direction of the high stretchability in the separator is orthogonal to the coating direction of the active material.

9. The electricity storage device according to claim 6, wherein the separator is configured by biaxial stretching, in which separator material is stretched in two directions orthogonal to each other, and one of the two axes has higher stretchability than the stretchability of the other axis.

10. The electricity storage device according to claim 6, wherein the electricity storage device is a rechargeable battery.
